(19) United States
(12) Patent Application Publication
(10) Pub. No.: US 2014/0111492 A1
(43) Pub. Date: Apr. 24, 2014

(54) ELECTRONIC DEVICE WITH MICRO-PROJECTOR AND PROJECTING METHOD

(71) Applicant: HON HAI PRECISION INDUSTRY CO., LTD., New Taipei (TW)

(72) Inventor: YUAN-TAO LIANG, New Taipei (TW)

(73) Assignee: HON HAI PRECISION INDUSTRY CO., LTD., New Taipei (TW)

(21) Appl. No.: 13/693,220

(22) Filed: Dec. 4, 2012

(30) Foreign Application Priority Data
Oct. 19, 2012 (TW) 101138686

(51) Int. Cl. G09G 5/10

(52) U.S. Cl. CPC G09G 5/10
USPC 345/207

(57) ABSTRACT

A method of adjusting projector output according to environment, by an electronic device with micro-projector, is provided. The method includes capturing environmental information by a camera; adjusting the brightness of projector light source according to environmental information; and adjusting colors of contents for projection onto a particular screen. The electronic device is also provided.

### BACKGROUND

1. Technical Field

The present disclosure relates to electronic devices with micro-projector which is adjustable according to environment and projecting method thereof.

2. Description of Related Art

Miniaturized projectors are widely used. However, the readability of any projected image may be greatly affected by ambient light conditions and the type of the screen on which the projection should be visible. For example, white color does not appear white if white balance is not properly adjusted to match the light source type, and the effect of the projection is decreased if the background color of the projected images does not match with the color of the screen.

Therefore, it is desirable to provide an electronic device and a method for adjusting the projected output according to environment, which can overcome the above-mentioned shortcomings.

### BRIEF DESCRIPTION OF THE DRAWINGS

FIG. 1 is a functional block diagram of an electronic device with micro-projector of which the projected output is capable of being adjusted according to environment, according to a first embodiment.

FIG. 2 is a flowchart showing a method for adjusting projected output according to environment, by the electronic device of FIG. 1.

FIG. 3 is a functional block diagram of an electronic device with micro-projector of which the projected output is capable of being adjusted according to environment, according to a second embodiment.

FIG. 4 is a flowchart showing a method for adjusting projected output according to environment, by the electronic device of FIG. 3.

### DETAILED DESCRIPTION

Embodiments of the disclosure will be described with reference to the accompanying drawings.

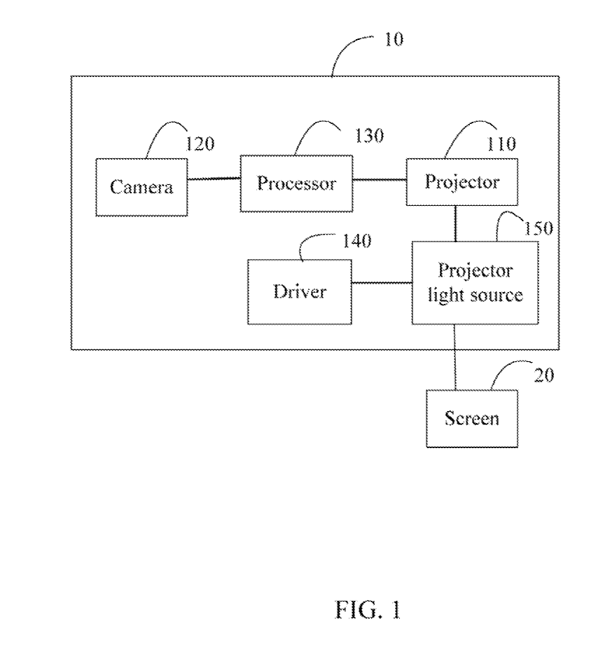

Referring to FIG. 1, a portable electronic device 10, according to a first embodiment, includes a projector 110, a camera 120, a processor 130, a driver 140, and a projector light source 150. The projector 110 is configured to project images onto a screen 20.

The camera 120 is configured to capture images of area around the projector 110, recognize light source types, and calculate brightness of ambient light or lights. For example, the camera 120 can analyze the color temperature of the ambient lights and thus determine the light source type of the ambient lights using the following exemplary table.

| Light Source type | Color Temperature in Kelvins |
|---|---|
| Clear Blue Sky | 10,000 to 15,000 |
| Overcast Sky | 6,000 to 8,000 |
| Noon Sun and Clear Sky | 6,500 |
| Sunlight Average | 5,400 to 6,000 |
| Electronic Flash | 5,400 to 6,000 |
| Household Lighting | 2,500 to 3,000 |
| 200-watt Bulb | 2,980 |
| 100-watt Bulb | 2,900 |
| 75-watt Bulb | 2,820 |
| 60-watt Bulb | 2,800 |
| 40-watt Bulb | 2,650 |

The camera 120 calculates the brightness of the ambient lights from the captured images or directly measures the brightness of the ambient lights using a photo detector.

The processor 130 performs any white balance process which is required on the contents to be projected by the projector 110. The white balance processes are performed on basis of the light source type of the ambient lights.

The driver 140 adjusts the brightness of the projector light source 150, according to the brightness of the ambient lights. For example, in a dark room, the brightness of the projector light source 150 should be lower, and the driver 140 can adjust the projector light source 150 to output less light. Outside, in sunlight, a higher brightness of the projector light source 150 is required, and the driver 140 can adjust the projector light source 150 to output more light.

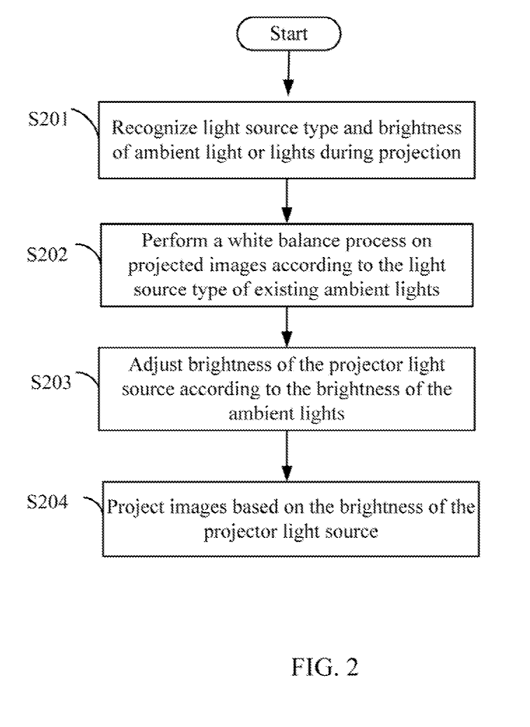

Referring to FIG. 2, an exemplary method for projecting images implemented by the portable electronic device 10 includes the following steps S201-S204.

In step S201, the camera 120 recognizes the light source type and brightness of ambient light or lights during the projection.

In step S202, the processor 130 performs a white balance process on the projected images according to the light source type of the existing ambient lights.

In step S203, the driver 140 adjusts the brightness of the projector light source 150 according to the brightness of the ambient lights.

In step 204, the projector 110 projects the images based on the brightness of the projector light source 150.

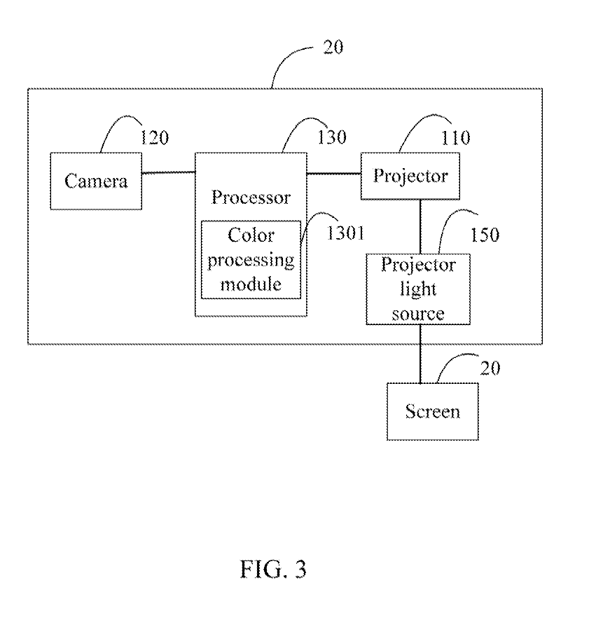

Referring to FIG. 3, a portable electronic device 20, according to another embodiment, is essentially similar to the portable electronic device 10, but it further includes a color processing module 1301 in the processor 130. The camera 120 recognizes the color of the screen 20 on which the projection is visible. For example, the camera 120 can capture images of the screen 20 and analyze the color of the screen 20. The color processing module 1301 adjusts the background color of each of the projected images, to match the color of the screen 20, and adjusts the foreground color of each of the projected images to a color, which is in high contrast to the color of the display screen 20, thus increasing the readability of the presentation.

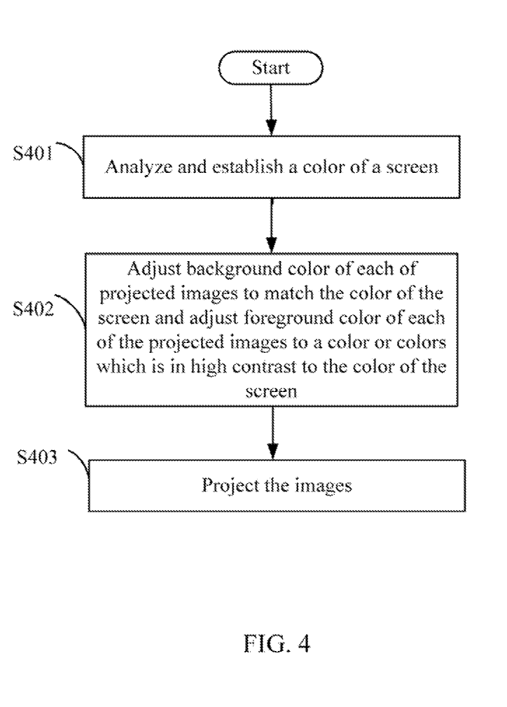

Referring to FIG. 4, a method for projecting content according to another embodiment, is carried out by the portable electronic device 20 and includes the following exemplary steps S404-S403.

In step S401, the camera 120 analyzes and establishes the color of the screen 20.

In step S402, the color processing module 1301 adjusts the background color of each of the projected images to match the color of the screen 20, and it adjusts the foreground color of each of the projected images to a color or colors which is in high contrast to the color of the screen 20.

In step S103, after adjusting the brightness of the projector light source 150 and the images for projection as required, the projector 110 projects the images.

Through the method above, the electronic device 10 adjusts the projection output, in respect of brightness, and the foreground and background colors respectively, according to the brightness of the ambient light of the environment and the color of the display screen 20.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An electronic device with micro-projector capable of adjusting output of projecting according to environment, the electronic device comprising:
a projector;
a camera, configured to capture environmental information;
a projector light source, configured to provide lights for the projector; and
a processor, configured to adjust contents to be projected according to the environmental information;
wherein the projector is configured to project the adjusted contents onto a screen, according to the lights provided by the projector light source.

2. The electronic device according to claim 1, wherein the camera is configured to capture images of an area around the projector and to recognize light source type of ambient lights, and the processor is configured to perform white balance processes on the contents to be projected on basis of the light source type of the ambient lights.

3. The electronic device according to claim 2, further comprising a driver, wherein the camera is configured to calculate brightness of ambient lights, and the driver is configured to adjust the brightness of the projector light source according to the brightness of the ambient lights.

4. The electronic device according to claim 3, wherein the camera is configured to calculate the brightness of the ambient lights using the images or to directly measure the brightness of the ambient lights using a photo detector.

5. The electronic device according to claim 3, wherein in a darker room, a lower brightness of the projector light source is required by the projector, and the driver is configured to adjust the projector light source to output less light, while at sunlight outside, a higher brightness of the projector light source is required by the projector and, accordingly, the driver is configured to adjust the projector light source to output more light.

6. The electronic device according to claim 1, wherein the processor further comprises a color processing module, the camera is configured to recognize a color of the screen, the color processing module is configured to adjust a background color of the contents to be projected to the color of the screen and to adjust a foreground color of the contents to be projected to a color which is in high contrast to the color of the screen.

7. A projecting method of adjusting output of projecting according to environment by an electronic device with micro-projector, comprising:
capturing environmental information by a camera;
adjusting contents to be projected according to the environmental information; and
projecting the adjusted contents onto a screen according to the lights provided by a projector light source via a projector.

8. The projecting method according to claim 7, further comprising:
capturing images of an area around the projector;
recognizing a light source type of ambient lights by the camera; and
performing white balance processes on the contents to be projected on basis of the light source type of the ambient lights.

9. The projecting method according to claim 8, further comprising:
calculating brightness of the ambient lights by the camera; and
adjusting the brightness of the projector light source according to the brightness of the ambient lights by a driver.

10. The projecting method according to claim 9, further comprising:
calculating the brightness of the ambient lights using the images or directly measuring the brightness of the ambient lights using a photo detector.

11. The projecting method according to claim 9, wherein the projector light source is adjusted to output less light by the driver when projecting in a darker room and a lower brightness of the projector light source is required by the projector, and the projector light source is adjusted to output more light by the driver when projecting at sunlight outside and a higher brightness of the projector light source is required by the projector.

12. The projecting method according to claim 8, further comprising:
recognizing a color of the screen;
adjusting a background color of the contents to be projected to the color of the screen and a foreground color of the contents to be projected to a color which is in high contrast of the color of the screen.
